(19) United States
(12) Patent Application Publication
(10) Pub. No.: US 2010/0132417 A1
(43) Pub. Date: Jun. 3, 2010

(54) KEY INTERLOCK FOR USE IN VEHICLES

(75) Inventor: Jin Sang Chung, Suwon-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/507,546

(22) Filed: Jul. 22, 2009

(30) Foreign Application Priority Data
Nov. 28, 2008 (KR) 10-2008-0119617

(51) Int. Cl. G05G 5/08; E05B 65/12; B60R 25/02

(52) U.S. Cl. 70/248; 74/483 R

(57) ABSTRACT

A key interlock system for use in a vehicle may include a start key having a locking groove and inserted into a start key receiving groove formed in an operating knob which is rotatably received in a switch box, a stopper selectively connecting the switch box with the start key, wherein the stopper includes a body configured to be inserted into the locking groove of the switch key through the switch box and the operating knob, an elastic member resiliently supporting the stopper in a direction against the operating knob, and an actuator generating an operating force to the stopper against an elastic force of the elastic member to selectively insert the stopper into the locking groove of the start key when a shift lever is in any position except for a parking position and the start key is rotated from an ON position to an ACC position.

### CROSS-REFERENCE TO RELATED APPLICATION

The present application claims priority to Korean Patent Application Number 10-2008-119617, filed on Nov. 28, 2008, the entire contents of which are incorporated herein for all purposes by this reference.

### BACKGROUND OF THE INVENTION

1. Field of the invention

The present invention relates to a key interlock for use in vehicles, and more particularly, to a key interlock capable of preventing an ignition key from being released when a shift lever is in any position except that the shift lever is in a parking position.

2. Description of Related Art

In general, a transmission for use in vehicles employs a key interlock system which can allow a start key to be released only when a shift lever is in a parking position.

FIG. 1 is a view illustrating a conventional key interlock, and FIG. 2 is a view explaining the operation of the key interlock.

The conventional key interlock includes, as shown in FIGS. 1 and 2, a parking position switch for detecting shift of a shift lever which is moved to any position except that a shift lever is moved to a parking position P, and a controller (not shown) receiving a signal to notify the controller of the current position of the shift lever.

As the controller receives and verifies the signal, the controller supplies a power to a solenoid 11 in order to operate a key interlock device 10.

If the power is applied to the solenoid 11, a push unit 12 connected to the solenoid is pushed down by the solenoid 11, with the push unit prevailing against the resilient force of a spring 13. Then, the push unit 12 is locked into a cam shaft 14 not to move the cam shaft 14, and thus prevents release of a key.

That is, in the case where the shift lever is in any position except for the parking position P, it prevents the release of the key.

Meanwhile, if the shift lever is in the parking position P, the controller interrupts the supply of the power to the solenoid 11, and the push unit 12 is drawn out from the cam shaft 14 to allow the cam shaft 14 to move, thereby releasing the key.

With the conventional key interlock device 10, however, if the key is rotated to a lock position in a state that the push unit 12 is in an ACC position to unlock the cam shaft 14, the key may be released even though the shift lever is in any position except for the parking position. Since a rotation angle of the key is small (e.g. 55 degrees when showing in FIG. 2), the cam shaft 14 is rotated and is in the lock position before the push unit 12 blocks the rotation of the cam shaft 14 by using the solenoid 11.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide key interlock capable of preventing an ignition key from being released when a shift lever is in any position except that the shift lever is in a parking position.

The key interlock system for use in a vehicle, may include a start key provided with a locking groove on its side portion and configured to be inserted into a start key receiving groove formed in an operating knob which is rotatably received in a switch box; a stopper selectively connecting the switch box with the start key, wherein the stopper includes a body configured to be inserted into the locking groove of the switch key through the switch box and the operating knob; an elastic member resiliently supporting the stopper in a direction against the operating knob; and an actuator generating an operating force to the stopper against an elastic force of the elastic member to selectively insert the stopper into the locking groove of the start key when a shift lever is in any position except for a parking position and the start key is rotated from an ON position to an ACC position.

The actuator may include a solenoid generating a magnetic force to apply the operating force to the stopper.

The stopper may have a rear end portion with an inclined surface, and the actuator includes an inclined surface at its front end portion which comes in close contact with the inclined surface of the stopper.

With the above description, the key interlock system is adapted so that the start key is not released even though the start key is quickly rotated from an ON position to an ACC position when the shift lever is in the parking position. Therefore, the present invention can prevent the accident from occurring and improve safety of passengers.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating a conventional key interlock.

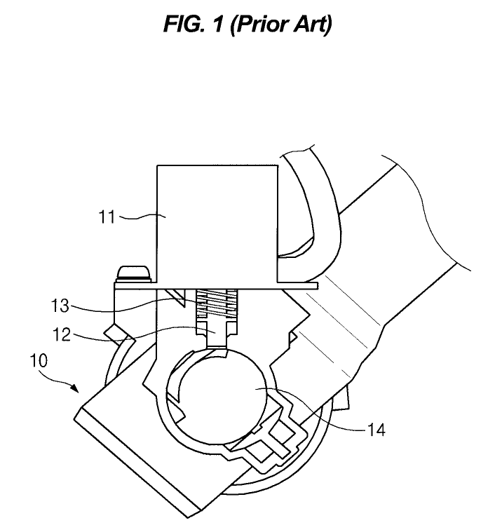

FIG. 2 is a view explaining the operation of the key interlock.

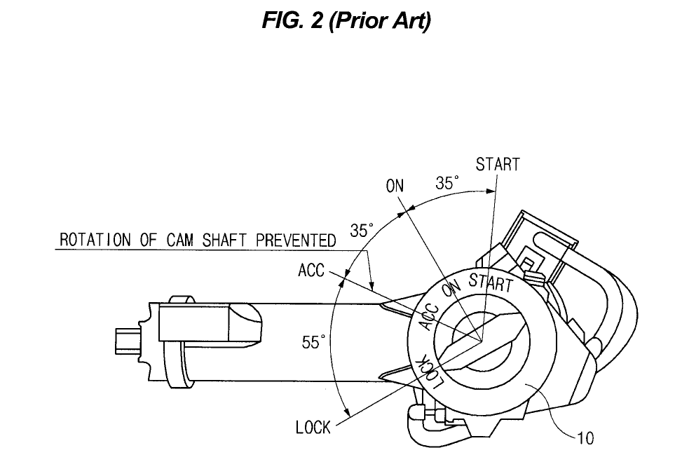

FIG. 3 is a view illustrating an exemplary key interlock system according to the present invention.

FIG. 4 is a table of power distribution of an ignition switch for use in an exemplary key interlock system according to the present invention.

FIG. 5 is a cross-sectional view illustrating an exemplary key interlock according to the present invention.

FIG. 6 is an enlarged view of portion A in FIG. 5.

FIG. 7 is a view illustrating the operation of an exemplary key interlock according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

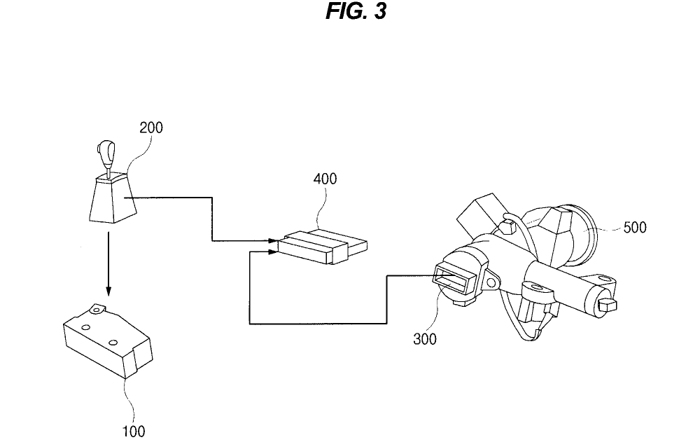

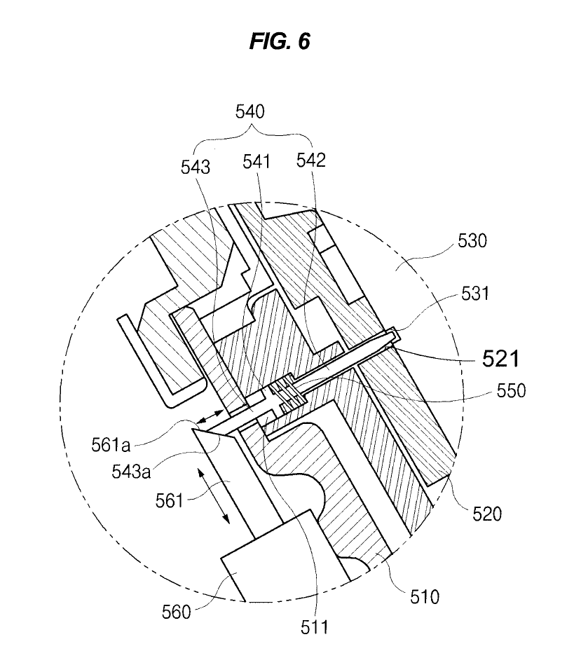

Hereinafter, a key interlock for use in vehicles according to various embodiments of the present invention will now be described with reference to FIGS. 3 to 7.

A key interlock system according to various embodiments of the present invention includes, as shown in FIG. 3, a parking position switch 100 for determining whether a shift lever 200 is in a parking position, an ignition switch 300 connected to any one of power terminals to supply a power to various electronic/electric parts from a battery in accordance with manipulation of a start key, and a key interlock controller 400 for determining operation of a key interlock 500 by combining a signal detected by the parking position switch 100 and a signal detected by the ignition switch 300.

The parking position switch 100 is installed to the shift lever 200 to determine whether the shift lever 200 is in a parking (P) position or not.

More specifically, if a driver positions the shift lever 200 at the parking position, the parking position switch 100 generates an ON signal to indicate that the shift lever 200 is in the P position.

If the driver positions the shift lever 200 at a reverse (R), neutral (N), drive (D), first or second position, except for the P position, the parking position switch 100 generates an OFF signal to indicate that the shift lever 200 is in any position except for the P position.

The ignition switch 300 is installed to the key interlock 500, and the key interlock 500 supplies the power to the electronic/electric parts from the battery in accordance with manipulation of the ignition key provided in the ignition switch 300.

The key interlock 500 is provided with ROCK, ACC, ON, and START positions, and ignition key may be positioned at the respective terminals.

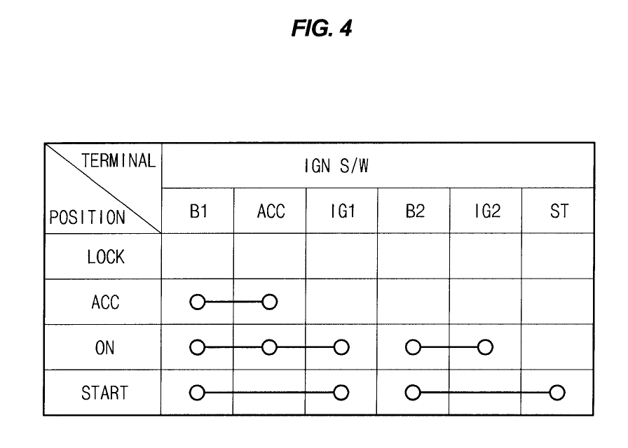

The ignition switch 300 is connected to a B1 terminal and the ACC position if the ignition key is at the ACC position. If the ignition key is at the ON position, the B1 terminal is connected to the ACC position and an IG1 terminal, and simultaneously a B2 terminal is connected to an IG2 terminal, as shown in FIG. 4. If the ignition key is at the start position, the B1 terminal is connected to the IG1 terminal, and simultaneously the B2 terminal is connected to an ST terminal.

The IG1 is to supply the power to a fuel circuit, an ignition circuit, an electronic controller, a direction indictor, and a reverse light, and the IG2 is to supply the power to a light unit, a security unit, an air conditioning unit, and a power window unit.

The ACC position is to supply the power to a watch and an audio appliance, and the ST terminal is to supply the power to a start circuit. The B1 is a battery power for electronic/electric parts related to the ACC position and the IG1, and the B2 terminal is a battery power for electronic/electric parts related to the ST terminal and the IG2 terminal.

The key interlock controller 400 is to determine the operation of the key interlock 500 which will be described hereinafter. The determination in the operation of the key interlock 500 is implemented by the signals generated from the parking position switch 100 and the ignition switch 300.

More specifically, if the shift lever 200 is in a parking position, receives an ON signal from the switch 100, and the controller 400 receives an IG1 from the ignition switch 300, the controller 400 does not operate the key interlock 500 so that the start key can be released from the key interlock 500. However, the controller 400 operates the key interlock 500 in response to other signals to prevent the start key from being released from the key interlock 500.

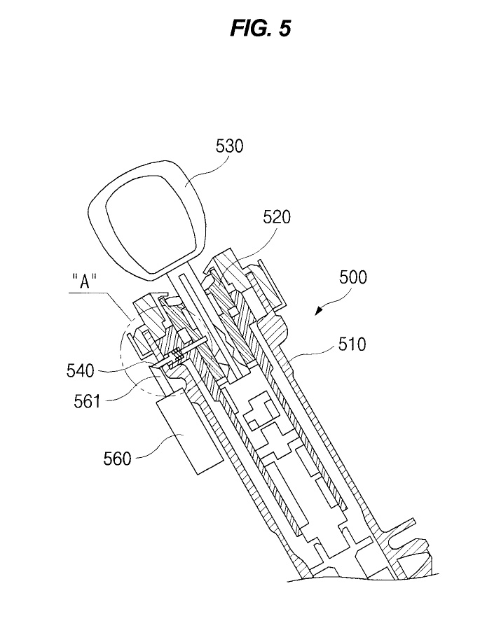

The key interlock 500 is to allow the start key to release from the ignition switch only when the shift lever 200 is in the parking position. The key interlock 500 includes, as shown in FIG. 5, a switch box 510 built in a dash board adjacent to a steering wheel, an operation knob 520 rotatably connected to the switch box 510 and provided with a start key receiving groove on its inner surface, a start key 530 inserted into the groove of the operation knob 520 and rotating the operation knob 520, the start key 530 being provided with a locking groove 531 on its side portion, a stopper 540 inserted into the groove 511 formed on the side of the switch box 510 and having a front end portion penetrating through the hole 521 formed on the side of the operation knob 520 and inserted into the locking hole 531, a spring 550 provided in the groove 511 and resiliently supporting the stopper 540 in a direction opposite to the locking groove 531, and a solenoid 560 generating a magnetic force to insert the stopper 540 into the locking groove 531 when the shift lever 200 is in any position except for the parking position and the start key 530 is rotated from the ON position to the ACC position.

The stopper 540 includes a support portion 541 movably inserted into the groove 511, a locking portion 542 formed on one side of the support portion 541 and having a front end portion selectively inserted into the groove 531, and a movable portion 543 extending from the other side of the support portion beyond the switch box 510 and having a rear end portion with an inclined surface 543a.

More specifically, if the rod 561 of the solenoid 560 is pulled out, the inclined surface 543a of the movable portion 543 is pressurized along the inclined surface 561a of the rod 561, and the stopper 540 is moved and inserted into the locking groove 531 of the start key 530, thereby locking the start key 530 and preventing release of the start key.

In this instance, the spring 550 is compressed by the support portion 541.

And then, if the power of the solenoid 560 is intercepted, the rod 561 is returned to its original position, and the support portion 541 is returned to its original position by the resilient restoring force of the spring 550. The locking portion 542 is released from the locking groove 531, and the locking state of the start key 530 is released.

The operation of the key interlock for use in vehicles according to various embodiments of the present invention will now be described.

Explaining the key interlock system in brief, first of all, it is determined whether the IG1 is in ON state on the basis of the ignition switch 300. Wherein, the state where the IG1 is in ON state means that the ignition key is in an ON or START position.

The controller 400 determines whether the ON signal is generated from the parking position switch 100.

The ON signal means that the shift lever 200 is in the parking position. The controller 400 does not operate the key interlock 500 by turning off the solenoid 560.

More specifically, if the shift lever 200 is in the parking position, the key interlock 500 is not operated, and thus the start key 530 may be released from the operation knob 530.

If the ON signal is not generated from the parking position switch 100, it is determined that the shift lever 200 is in any positions.

In this instance, if the IG1 is not ON, it is determined that the start key 530 is in the LOCK or ACC position, and the key interlock 500 is operated by turning off the solenoid 560, thereby preventing the release of the start key 530.

Meanwhile, in the case where the shift lever 200 is in any position except for the parking position, that is, the start key 530 is in the ON position while driving, the key interlock 500 does not operated.

When the start key 530 is quickly rotated from the ON position to the ACC position, the IG1 detects the OFF. Thus, the solenoid 560 is turned off to operate the key interlock 500 and prevent the release of the start key 530.

More specifically, if the solenoid 560 is turned on, the rod 561 of the solenoid 560 is drown out, and the inclined surface 541a of the stopper 540 is pressurized and moved. And thus, the locking portion 542 is inserted into the locking groove 531 of the start key 530 to prevent the release of the start key 530.

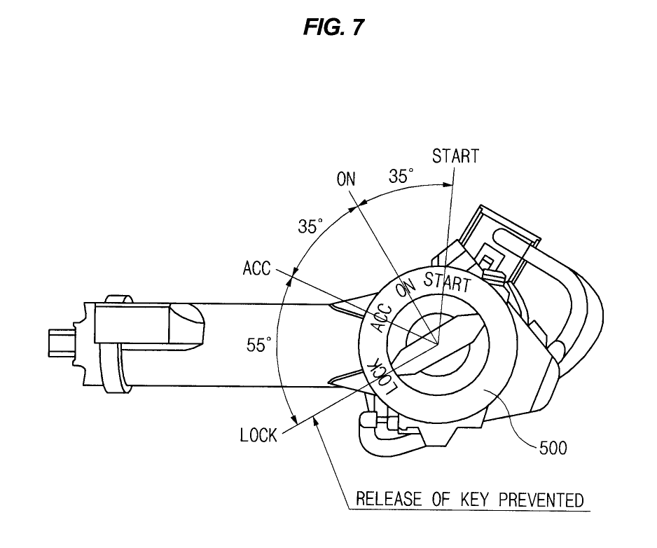

As shown in FIG. 7, even though the start key 530 is quickly rotated from the ON position to the ACC position at small rotation angle (e.g. 55 degrees when viewing from FIG. 5), it can prevent the release of the start key 530 through the key interlock 500 and thus improve the safety of the vehicle.

If the start key 530 is not rotated from the ON position to the ACC position in a state that the shift lever 200 is in the parking position, the power is not applied to the solenoid 560. And then, if the shift lever 200 is moved to the parking position, the start key 530 can be normally released.

The key interlock 500 is operated while the shift lever 200 is in any positions except for the parking position. In order to move the shift lever 200 to the parking position, the start key 530 is moved to the ON position, and then the shift lever is moved.

In this instance, when the start key 530 is in at the ON position, the IG1 becomes ON to intercept the power of the solenoid 560. And thus, the stopper 540 is returned to its original position by the restoring force of the spring 550 to release the start key 530.

For convenience in explanation and accurate definition in the appended claims, the terms “front”, “rear”, and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A key interlock system for use in a vehicle, comprising:
a start key provided with a locking groove on its side portion and configured to be inserted into a start key receiving groove formed in an operating knob which is rotatably received in a switch box;
a stopper selectively connecting the switch box with the start key, wherein the stopper includes a body configured to be inserted into the locking groove of the switch key through the switch box and the operating knob;
an elastic member resiliently supporting the stopper in a direction against the operating knob; and
an actuator generating an operating force to the stopper against an elastic force of the elastic member to selectively insert the stopper into the locking groove of the start key when a shift lever is in any position except for a parking position and the start key is rotated from an ON position to an ACC position.

2. The key interlock system as claimed in claim 1, wherein the actuator includes a solenoid generating a magnetic force to apply the operating force to the stopper.

3. The key interlock system as claimed in claim 1, wherein the stopper has a rear end portion with an inclined surface, and the actuator includes an inclined surface at its front end portion which comes in close contact with the inclined surface of the stopper.
